(19) United States
(12) Patent Application Publication
(10) Pub. No.: US 2005/0237398 A1
(43) Pub. Date: Oct. 27, 2005

(54) Recording-medium accommodating apparatus and digital camer

(75) Inventors: Naoki Fujii, Tokyo (JP); Yoichi Washizu, Tokyo (JP); Masahide Kawakubo, Tokyo (JP); Shunji Matsutani, Tokyo (JP)

Correspondence Address: FRISHAUF, HOLTZ, GOODMAN & CHICK, PC, 220 5TH AVE FL 16, NEW YORK, NY, 10001-7708, US

(73) Assignee: Olympus Corporation, Tokyo (JP)

(21) Appl. No.: 11/155,914

(22) Filed: Jun. 14, 2005

Related U.S. Application Data
(63) Continuation of application No. PCT/JP03/16695, filed on Dec. 25, 2003.

(30) Foreign Application Priority Data
Dec. 27, 2002 (JP) 2002-382356

(51) Int. Cl. H04N 5/76

(52) U.S. Cl. 348/231.99

(57) ABSTRACT

A recording-medium accommodating apparatus of a digital camera includes a connector/card chamber on the left thereof, and a connector cover, to which a waterproof packing is attached and which opens the connector/card chamber. The connector/card chamber includes a card connector, an inserting opening thereof, a video output terminal portion, a USB terminal portion, and a card cover which opens/closes the inserting opening. In the non-connection of the terminal portion, a memory card is attached, the card cover is closed, the connector cover is closed, and data is then written/read to/from the memory card. In the connection of the terminal portion, the data is written/read to/from the memory card with the connector cover opened. The recording-medium accommodating apparatus further includes a cover member which protects a connector portion between the recording medium and an external device, the recording medium is protected and the connector is used. Thus, data is certainly recorded/read to/from the recording medium.

### CROSS REFERENCE TO RELATED APPLICATION

This application is a continuation application of PCT/JP03/16695 filed on Dec. 25, 2003 and claims benefit of Japanese Application No. 2002-382356 filed in Japan on Dec. 27, 2002, the entire contents of which are incorporated herein by this reference.

### BACKGROUND OF THE INVENTION

1. Field of the Invention

The present invention relates to a recording-medium accommodating apparatus which accommodates the recording medium for recording a shot image, sound and the like, and a digital camera having the recording-medium accommodating apparatus.

2. Description of the Related Art

Conventionally, a main body of a mobile device, such as a digital camera, comprises an accommodating unit of a recording medium for recording data and a connector (USB connector or an NTSC connector) for inputting and outputting data, which can externally be exposed. The recording medium records image data or audio data and, generally, the recording medium in the mobile device, such as a digital camera, is manually attached/detached. The recording medium is manually attached/detached as mentioned above because the device size increases and the power consumption of a battery is large when the device has an automatic discharge mechanism of the recording medium.

Since the recording medium is manually detached as mentioned above, data in progress of writing is invalid and a recording unit of the recording medium might be destructed in some cases when a user carelessly discharges the recording medium during writing/reading the data to/from the recording medium.

In order to prevent the above-mentioned trouble, Japanese Unexamined Patent Application Publication No. 2001-203921 discloses a recording-medium accommodating apparatus in a digital camera, wherein a recording-medium accommodating unit comprises a closable cover and a sensor for sensing the closing and opening operation of the cover and the data reading/writing operation (access) is prohibited when the cover is opened and the access operation forcedly ends when the cover is opened during the access operation, thus protecting the recording medium.

Further, Japanese Unexamined Patent Application Publication No. 2001-147472 discloses a recording-medium accommodating apparatus of a camera apparatus, wherein a protecting cover is provided for an eject button of the recording medium to prevent the careless discharge operation.

Furthermore, Japanese Unexamined Patent Application Publication No. 2000-131745 discloses a digital camera with a preferable structure for compact camera, wherein a medium accommodating unit and an external connector are arranged at the same position and the same cover protects the medium accommodating unit and the external connector.

### SUMMARY OF THE INVENTION

According to the present invention, there is provided a recording-medium accommodating apparatus having a cover member for protecting the recording medium and a connector unit to an external device, in which the protection of the recording medium and the use of the connector are simultaneously realized and the recording and reading operations to/from the recording medium are possible without fail.

According to one aspect of the present invention, a recording-medium accommodating apparatus comprises: an opening through which recording medium is accommodated; a connector unit which is arranged near the opening and electrically connects inner components; a discharge prohibiting unit which is arranged near the opening and selectively prohibits the discharge operation of the recording medium accommodated through the opening; and a cover member which is closable to externally protect the opening, the connector unit, and the discharge prohibiting unit.

According to another aspect of the present invention, a digital camera comprises the recording-medium accommodating apparatus. The recording medium records a shot image.

Other features and advantages of the present invention will be obvious by the following description.

### BRIEF DESCRIPTION OF THE DRAWINGS

FIG. 1 is a block diagram showing the structure of a digital camera including a recording-medium accommodating apparatus according to an embodiment of the present invention;

FIG. 2 is a perspective view showing the appearance of the camera shown in FIG. 1 (closing state of a lens barrier and a closing state of a connector cover);

FIG. 3 is a perspective view showing components around a connector unit/card attaching unit upon opening the connector cover of the camera shown in FIG. 1;

FIG. 4 is an exploded perspective view showing components around the card attaching unit of the camera shown in FIG. 1;

FIG. 5 is a perspective view of a card cover of the card attaching unit of the camera shown in FIG. 1 as viewed from a direction B shown in FIG. 4;

FIG. 6 is a perspective view showing components around the connector unit/card attaching unit of the camera shown in FIG. 1, including a video signal connecting plug and a USB connecting plug upon inserting a memory card;

FIG. 7 is a diagram showing a VII-VII cross section shown in FIG. 3, including an opening state of the connector cover and an opening state of the card cover; and

FIG. 8 is a diagram showing a VII-VII cross section shown in FIG. 3, including a closing state of the connector cover and a closing state of the card cover.

### DETAILED DESCRIPTION OF THE PREFERRED EMBODIMENTS

Hereinbelow, an embodiment of the present invention will be described with reference to the drawings.

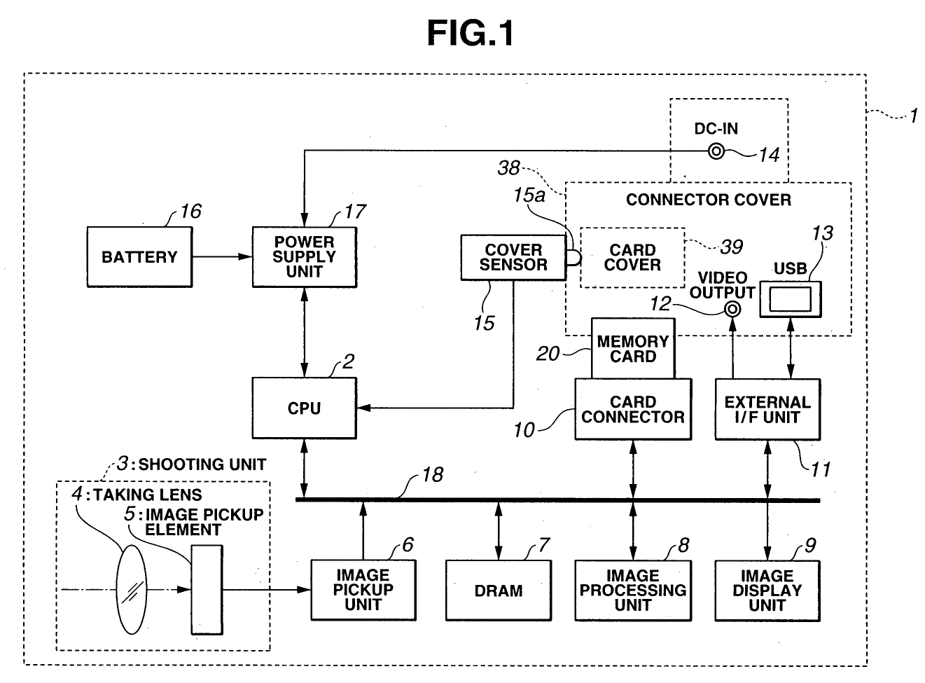

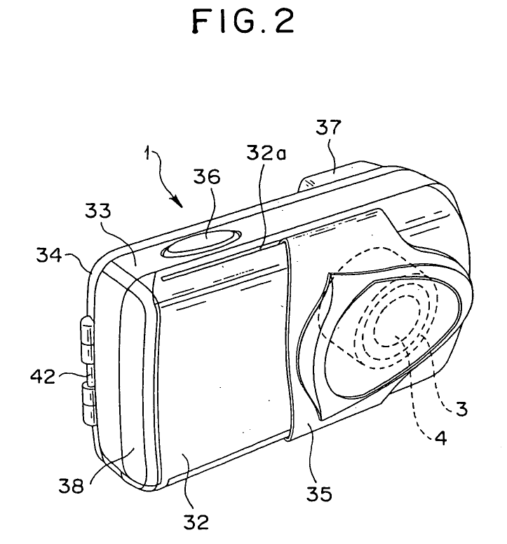

FIG. 1 is a block diagram showing the structure of a digital camera including a recording-medium accommodating apparatus according to an embodiment of the present invention. FIG. 2 is a perspective view showing the appearance of the camera shown in FIG. 1 (closing state of a lens barrier and a closing state of a connector cover).

Referring to FIG. 1, a digital camera (hereinafter, abbreviated to a camera) 1 according to the embodiment comprises: a CPU 2, serving as a control unit for entirely controlling the camera 1; a shooting unit 3 which captures a subject image of subject light, converts the captured image into an electrical image pickup signal, and outputs the signal; an image pickup unit (image pickup circuit unit) 6 which captures the electric image pickup signal and outputs a digital image pickup signal which can be image-processed; a DRAM 7 which temporarily stores the digital image signal; an image processing unit (image processing circuit unit) 8 which performs conversion of the digital image signal into an image data that can be recorded to a memory and can be displayed on a monitor; an image display unit (LCD display unit) 9 which displays the image data; a card connector 10 which can attach/detach a memory card 20, serving as a recording medium for recording the image data; an external I/F unit 11 which transfers the image data to an external device; a video output terminal unit 12 and a USB terminal unit 13, serving as connector units connected to an external I/F; a card cover 39, serving as a discharge prohibiting unit of the recording medium, which can be rotated at the position for covering the attached memory card 20; a cover sensor 15, serving as a sensing unit, which senses an opening/closing state of the card cover 39; a connector cover 38, serving as a cover member, which covers the card cover 39, the video output terminal unit 12, and the USB terminal unit 13; a power battery 16; a DC-IN terminal unit 14, serving as a connector for connection of an external power supply; and a power supply unit (power circuit unit) 17 which is connected to the power battery 16 and the DC-IN terminal unit 14 and supplies driving power to control circuit units.

Connected to the CPU 2, via a communication bus 18, are the image pickup unit 6, the DRAM 7, the image processing unit 8, the image display unit 9, the card connector 10, and the external I/F unit 11 and the like, thereby receiving and transmitting the data between the CPU 2 and the circuit units. Further, the CPU 2 controls the shooting operation, image processing, and image recording to the memory card and further controls an output voltage of the power supply unit 17.

The output of the cover sensor 15 is connected to the CPU 2, thereby capturing a cover opening/closing signal of the card cover 39. The CPU 2 controls the permission and prohibition of the recording and reading operation of shot image data to the memory card 20 in accordance with the opening/closing signal. That is, the CPU 2 controls the operation so that the recording and reading of the image data is permitted in response to an ON signal at the closing position for prohibiting the discharge operation of the memory card 20 by the card cover 39, and the recording and reading of the image data is prohibited in response to an OFF signal at the opening position for permitting the discharge operation of the memory card 20 by the card cover 39.

The shooting unit 3 comprises: a taking lens unit 4; and an image pickup element 5, such as a CCD, which is controlled via the image pickup unit 6. Information on a subject image captured via the taking lens unit 4 is converted into an electrical image pickup signal by the image pickup element 5. The electrical image pickup signal is subjected to digital processing by the image pickup unit 6, and is temporarily stored, as digital image data in the DRAM 7. The image data is subjected to compression/decompression for recording the data to the memory card 20 by the image processing unit 8.

Alternatively, the image data is subjected to display image processing for displaying the data onto the image display unit 9 or an external monitor.

Referring to FIG. 2, a case of the camera 1 according to the embodiment mainly comprises: a front cover 32; a middle cover 33; and a rear cover 34. The covers are formed by adhering metallic thin plates forming case surfaces to an inner cover containing resin by a both-side adhesive tape and adhesive. The front cover 32, the middle cover 33, and the rear cover 34 are integrated by inserting and screwing screws (not shown) upon assembling.

A lens barrier 35, which can be moved by the guide operation of a guide groove 32a in the right/left direction, is attached to the front portion of the front cover 32. The lens barrier 35 can be slid at the closing position for covering the taking lens unit 4 of the shooting unit (lens barrel unit) 3 incorporated in the front cover 32 and at the opening position for opening the front surface of the taking lens unit 4. When the lens barrier 35 is at the opening position, the taking lens unit 4 of the shooting unit 3 can be moved at the shooting position.

A release operation button 36 for instructing the shooting start is arranged on the top of the middle cover 33. A finder eyepiece unit 37 is arranged to the top on the rear of the rear cover 34.

The connector cover 38 rotatably supported is arranged at the side ends on the left of the front cover 32 and the middle cover 33. The connector cover 38 is a cover member which covers a connector unit/card attaching unit arranged on the left sides of the front cover 32 and the middle cover 33, which will be described later. When the connector cover 38 is closed, the connector cover 38 partly forms the outside surfaces of the camera together with the front cover 32, the middle cover 33, and the rear cover 34.

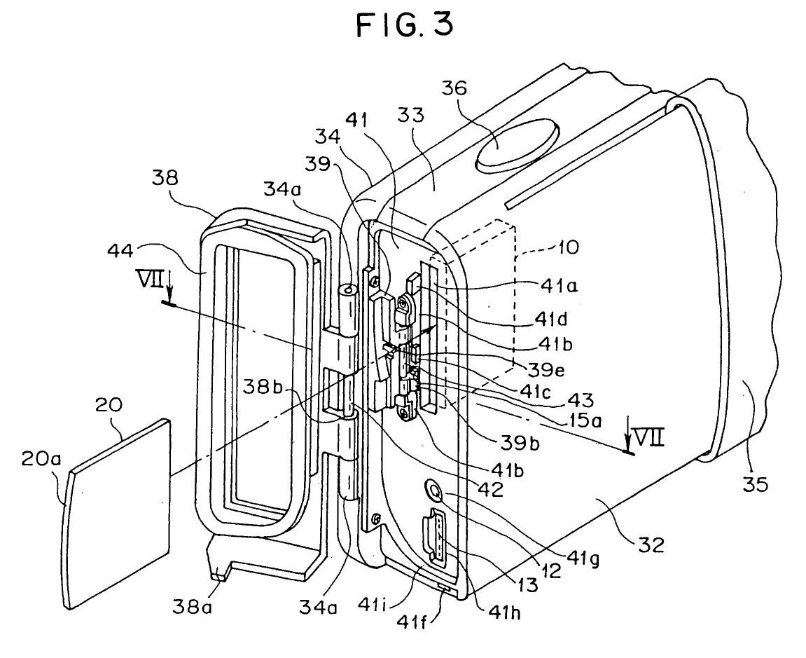

Next, a detailed description is given of the structure and the operations of an accommodating apparatus of a recording medium comprising the connector cover 38 and the connector unit/card attaching unit in the camera 1 according to the embodiment with reference to FIGS. 3 to 8.

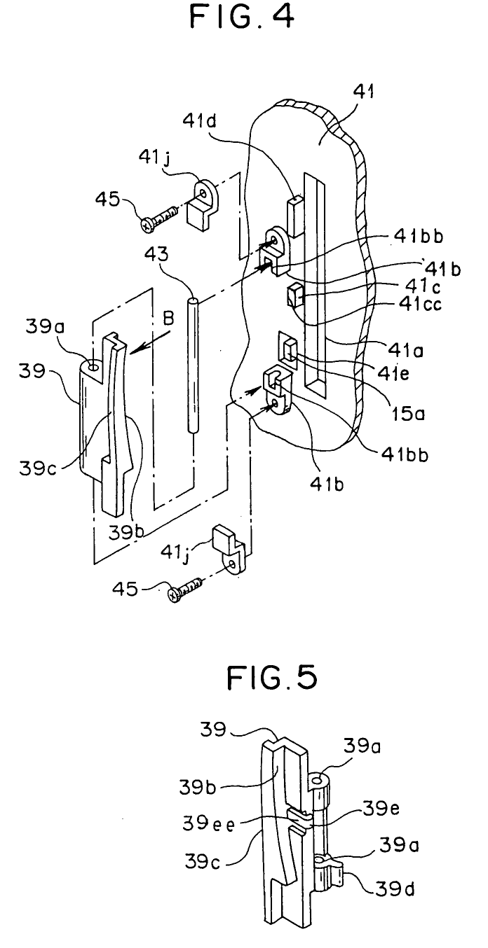

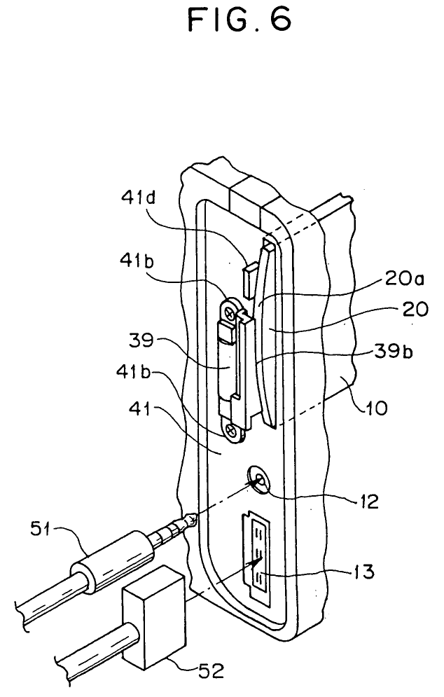

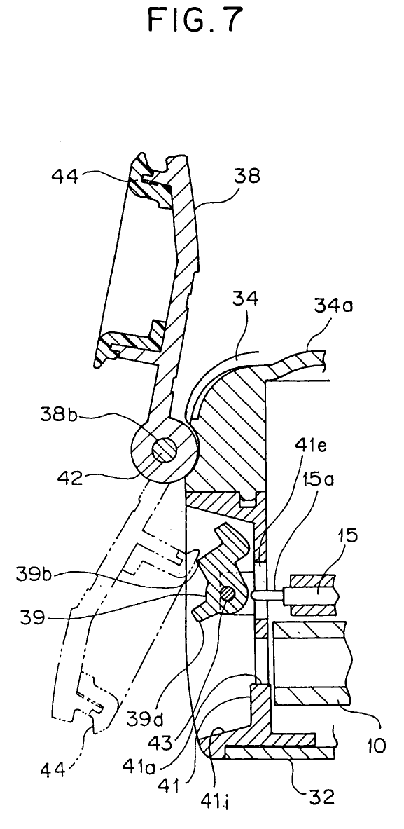

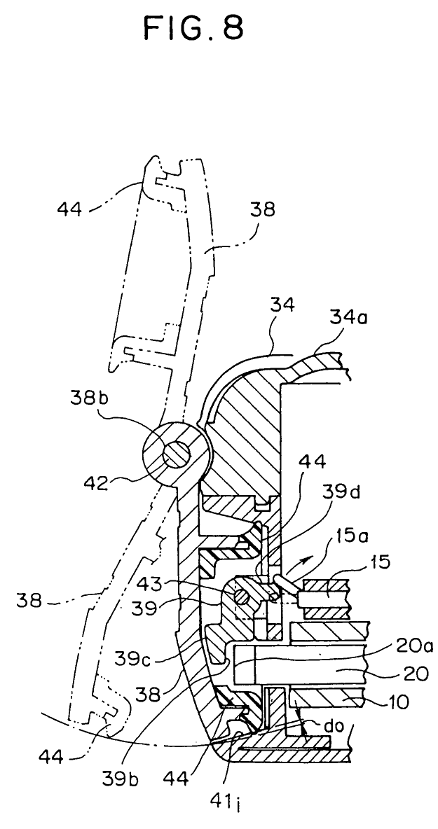

FIG. 3 is a perspective view showing components around the connector unit/card attaching unit upon opening the connector cover of the camera shown in FIG. 1. FIG. 4 is an exploded perspective view showing components around the card attaching unit of the camera shown in FIG. 1. FIG. 5 is a perspective view of a card cover of the card attaching unit of the camera shown in FIG. 1 as viewed from a direction B shown in FIG. 4. FIG. 6 is a perspective view showing components around the connector unit/card attaching unit of the camera shown in FIG. 1, including a video signal connecting plug and a USB connecting plug when a memory card is inserted. FIG. 7 is a diagram showing a VII-VII cross section shown in FIG. 3, including an opening state of the connector cover and an opening state of the card cover. FIG. 8 is a diagram showing a VII-VII cross section shown in FIG. 3, including a closing state of the connector cover and a closing state of the card cover.

The memory card 20 attached to the card attaching unit is a recording medium of a flash memory, and can be attached to the card connector 10 in the main body of the camera 1 via a card inserting opening 41a as shown in FIG. 3, which will be described later. An inserting and pressing side-end 20a of the memory card 20 forms a projected bending end surface. When the memory card 20 is pressed and inserted to a predetermined position of the card connector 10, a locking mechanism arranged in the card connector locks the memory card 20 at the attaching position. Upon repressing the inserting and pressing side-end 20a of the attached memory card 20, the locking operation is reset and thus the memory card 20 can be pulled out.

Referring to FIG. 3, the connector unit/card attaching unit arranged to the left of the front cover 32 and the middle cover 33 comprises: a connector/card chamber 41 arranged to the left of the front cover 32 and the middle cover 33; the card cover 39 which partly covers the attached memory card 20; a card cover shaft 43 which rotatably supports the card cover 39; a shaft pressing plate 41j for card cover shaft; the connector cover 38, serving as a cover member, which covers and protects a connector unit in the connector/card chamber 41, the card opening, and the card cover; and a connector cover shaft 42 which has a function of a hand strap shaft and rotatably supports the connector cover 38.

The connector/card chamber 41 comprises: an inner-circumferential wall surface 41i which surrounds a terminal opening for connector and an opening for inserting the card, which will be described later; a card inserting opening 41a arranged to the top; a video output terminal opening 41g and a USB terminal opening 41h arranged to the bottom; a projected portion 41d for preventing the card operation and a projected portion 41c for holding the closing position of the card cover arranged along the side surface of the card inserting opening 41a; a cover sensor opening 41e; and two shaft supporting blocks 41b.

The card connector 10 mounted on an electrical substrate (not shown) is inside the main body of the camera 1, facing the card inserting opening 41a.

The video output terminal (connector unit) 12 or the USB terminal (connector unit) 13 is arranged inside the main body of the camera of the video output terminal opening 41g and the USB terminal opening 41h. A video connecting plug 51 and a USB connecting plug 52 of an external device can be connected to the video output terminal unit 12 and the USB terminal unit 13, respectively (refer to FIG. 6).

The cover sensor 15 for sensing the opening/closing state of the card cover is arranged inside of the main body of the camera of the cover opening 41e (refer to FIGS. 7 and 8). An actuator 15a of the cover sensor 15 is slightly projected to the cover opening 41e.

Referring to FIG. 4, the two shaft supporting blocks 41b are separated, facing each other near the projected portions 41d and 41c along the card inserting opening 41a. Further, the two shaft supporting blocks 41b have caved portions 41bb in which a card cover shaft 43 is inserted.

The card cover 39 comprises a shaft hole 39a in which the card cover shaft 43 is rotatably fit, a card facing portion 39b, serving as a caved cover portion, along the bending shape of the inserting and pressing side-end 20a of the memory card 20 inserted in the shaft hole 39a in parallel, a back portion 39c, a projected portion 39d for pressing the cover sensor arranged at the facing position of the cover opening 41e on the boss surface on the down side of the shaft hole 39a, and a projected portion 39e at the facing position of the projected portion 41c for holding the closing position of the card cover on the side of the card facing portion 39b.

The card cover 39 is rotatably supported to a shaft supporting blocks 41b via the card cover shaft 43. That is, the card cover shaft 43 inserted in the shaft hole 39a of the card cover 39 is inserted in caved portions 41bb of the shaft supporting blocks 41b, and both ends of the card cover shaft 43 are pressed by the shaft pressing plate 41j and are fixed to the shaft supporting blocks 41b by using screws 45. The attached card cover 39 is rotatably supported to the shaft supporting blocks 41b.

When the card cover 39 is at the closing position for covering the memory card 20, a side surface 39ee of the projected portion 39e in the card cover 39 comes into contact with a side surface 41cc of the projected portion 41c for holding the closing position of the card cover 39 on the connector/card chamber 41 side. Thus, the closing position of the card cover 39 is held. When the memory card 20 is attached to the card connector 10 and the card cover 39 is at the closing position, the card facing portion 39b of the card cover 39 is separated from the card inserting opening 41a by a predetermined distance, and covers the inserting and pressing side-end 20a of the memory card 20 with a small space. Thus, unnecessary force does not act to the memory card 20.

The up portion of the inserting and pressing side-end 20a of the memory card 20 is not covered by the card cover 39 and is partly exposed. The projected portion 41d for preventing the card operation of the connector/card chamber 41 is on the side of the exposed portion. The height of the projected portion 41d for preventing the card operation is substantially equal to the height of the inserting and pressing side-end 20a, where the projected portion 41d is located, of the memory card 20. Therefore, although the up portion of the memory card 20 is not covered by the card cover 39 as mentioned above, the memory card 20 is not pressed because of the existence of the projected portion 41d for preventing the card operation (refer to FIG. 6). The memory card 20 is pressed to pull out only by opening the card cover 39. That is, the memory card 20 with the card cover 39 at the closing position is not discharged, and the memory card 20 with the card cover 39 at the opening position is discharged.

When the card cover 39 is rotated toward the closing position thereof, the actuator 15a of the cover sensor 15 is pressed in the ON-direction by the projected portion 39d for pressing the cover sensor (refer to FIG. 8). When the card cover 39 is at the closing position, the cover sensor 15 outputs an ON-signal to the CPU 2.

The connector cover 38 is rotatably supported while the connector cover shaft 42 inserted in the shaft supporting portion 34a of the rear cover 34 is fit into a shaft hole 38b. The rotation enables the connector/card chamber 41 to be opened/closed. The connector cover 38 comprises a frame rubber packing 44 forming a waterproof portion for making the connector portion or card opening watertight at the inner circumferential portion thereof.

When the connector cover 38 is at the closing position, referring to FIG. 8, the rubber packing 44 is fit by pressing the rubber packing 44 into the inner-circumferential wall surface 41i of the connector/card chamber 41 (interference in the pressing operation is designated by a dimension d0 shown in FIG. 8), thereby keeping the waterproof state of the card inserting opening 41a, the cover sensor opening 41e, the video output terminal opening 41g, and the USB terminal opening 41h of the inner-circumferential wall surface 41i and the card cover.

When the connector cover 38 is at the closing position, a projection 38a arranged to the down portion of the connector cover 38 is engaged with a caved portion 41f of the connector/card chamber 41 to be locked. When the locked connector cover 38 is rotated in the opening direction, the locking state is reset, thereby opening the connector cover 38.

A description is given of the attachment/detachment of the memory card and the relating operations in the camera 1 with the above-mentioned structure according to the embodiment with reference to FIGS. 7 and 8.

Referring to FIG. 7, the connector cover 38 is opened upon attaching the memory card 20. Further, the card cover 39 is opened. When the connector cover 38 is rotated in the closing direction while the card cover 39 is opened, the memory card 20 is incompletely attached to the card connector 10. Therefore, the rubber packing 44 of the connector cover 38 comes into contact with an edge portion of the card side-end 39b of the card cover 39 (refer to FIG. 7). Thus, a user recognizes that the connector cover 38 is not closed. That is, the user recognizes that the connector cover 38 is not closed before the warning operation of the cover sensor 15.

The memory card 20 is attached to the card connector 10 via the card inserting opening 41a and further the card cover 39 is closed. Then, the projected portion 39d for pressing the cover sensor presses the actuator 15a, and the cover sensor 15 outputs, to the CPU 2, the ON-signal indicating the closing state of the memory card 20. In this state, the connector cover 38 is rotated at the closing position, and the connector/card chamber is waterproof (refer to FIG. 8).

When the card cover 39 is at the closing position, namely, the connector cover 38 outputs the ON-signal and the memory card 20 is attached to the card connector 10, the image data processed by the image processing unit 8 is written to the memory card 20 via the card connector 10 in accordance with an instruction of the CPU 2.

When the card cover 39 does not completely reach the closing position, the closing operation of the connector cover 38 presses the back portion 39c of the card cover 39 with the inner surface of the connector cover 38, thereby rotating the card cover 39 at the normal closing position.

Referring to FIG. 6, when the video connecting plug 51 or the USB connecting plug 52 is connected to the video output terminal unit 12 or the USB terminal unit 13, the connector cover 38 is opened for connection.

When the data is written/read to/from the memory card 20 while the video connecting plug 51 or the USB connecting plug 52 is connected, the connector cover 38 is opened as mentioned above. However, when the card cover 39 is completely closed, the memory card 20 is not pressed as mentioned above. Therefore, the memory card 20 is not pulled out. Troubles, such as the stop operation of writing/reading of the data to/from the memory card 20, are not caused.

The DC-IN terminal (connector) unit 14 may be arranged in the connector/card chamber 41 together with the video output terminal unit 12 and the like.

In the camera 1 according to the embodiment, the connector terminal unit and the memory card (recording medium) attaching unit are protected by the connector cover 38, serving as one cover member, and both the connector terminal unit and the memory card (recording medium) attaching unit are protected to be watertight together therewith with the simple structure. Further, when an external cord is connected to the connector terminal and the connector cover 38 is opened, the attached memory card 20 is not pulled out by closing the card cover 39 for prohibiting the discharge operation. Thus, the data is written/read to/from the memory card 20 without fail.

The length of the card cover 39 for covering the memory card 20 in the longitudinal direction is set to partly cover the memory card 20. The projected portion 41d for preventing the card operation is arranged at the exposed portion from the card cover and, thus, the memory card 20 is not pressed. The length for covering the memory card 20 by the card cover 39 along the card inserting opening 41a is short.

Since the two covers are used by arranging the card cover 39 in the connector cover 38, the dimension of the arranging position of the cover (corresponding to the width dimension of the camera when the side end of the camera is expanded) is increased, as compared with the one cover. However, the length of the card cover is short according to the embodiment of the present invention as described above, and therefore the increase in volume and dimension of the arranging position of the cover due to the two covers is suppressed and the increase in size of the camera is prevented.

When the card cover 39 is not rotated at the closing position, namely, the memory card 20 can be pulled out, the connector cover 38 is not closed because the card cover 39 and the connector cover 38 interfere with each other. The user recognizes, without fail, that the card cover 39 is not normal.

Further, the CPU 2 recognizes, based on the output signal from the cover sensor 15, whether or not the card cover 39 is rotated at the closing position. Therefore, the data is written/read to/from the memory card 20 without fail.

In the recording-medium accommodating apparatus and the digital camera including the recording-medium accommodating apparatus according to the present invention, both the connector and the recording medium are protected by the single cover-member. Further, even when the cover member is opened, the careless discharge operation of the recording medium is prohibited by the discharge prohibiting unit. Thus, the data is written/read to/from the recording medium without fail.

Having described the preferred embodiments of the invention referring to the accompanying drawings, it should be understood that the present invention is not limited to those precise embodiments and various changes and modifications thereof could be made by one skilled in the art without departing form the spirit or scope of the invention as defined in the appended claims.

1. A recording-medium accommodating apparatus comprising:
an opening through which recording medium is accommodated;
a connector unit which is arranged near the opening and electrically connects inner components;
a discharge prohibiting unit which is arranged near the opening and selectively prohibits the discharge operation of the recording medium accommodated through the opening; and
a cover member which is closable to externally protect the opening, the connector unit, and the discharge prohibiting unit.

2. A recording-medium accommodating apparatus according to claim 1, wherein the discharge prohibiting unit comprises a cover unit which covers at least one part of an exposed end of the recording medium attached to the opening upon prohibiting the discharge operation.

3. A recording-medium accommodating apparatus according to claim 2, wherein a projected portion is formed near the opening along an uncovered portion of the discharge prohibiting unit at a projected end of the recording medium.

4. A recording-medium accommodating apparatus according to claim 1, wherein the discharge prohibiting unit is moved at the position for prohibiting the discharge operation of the recording medium and at the position for permitting the discharge operation thereof, and the discharge prohibiting unit prevents the movement to the closing position of the cover member at the opening position when the discharge prohibiting unit is at the position for permitting the discharge operation.

5. A recording-medium accommodating apparatus according to claim 1, wherein the cover member comprises a waterproof unit which externally makes the recording-medium accommodating apparatus waterproof.

6. A recording-medium accommodating apparatus according to claim 1, further comprising:
a sensing unit which senses that the discharge prohibiting unit is at the position for prohibiting the discharge operation.

7. A digital camera comprising the recording-medium accommodating apparatus according to claim 1,
wherein the recording medium records a shot image.

8. A digital camera according to claim 7, further comprising:
a control unit which controls the operation for permitting the recording of the shot image to the recording medium when the discharge prohibiting unit is at the position for prohibiting the discharge operation.

9. A digital camera according to claim 7, wherein the cover member partly forms an outside portion of the side surface of the camera.
